(19) United States
(12) Patent Application Publication
(10) Pub. No.: US 2024/0052124 A1
(43) Pub. Date: Feb. 15, 2024

(54) Fiber Materials for Use in Adhesives and Sealants

(71) Applicant: Zephyros, Inc., Romeo, MI (US)

(72) Inventors: Michael Czaplicki, Romeo, MI (US); Ira Miller, Romeo, MI (US)

(21) Appl. No.: 18/271,150

(22) PCT Filed: Jan. 5, 2022
(86) PCT No.: PCT/US2022/011235

§ 371 Date: Jul. 6, 2023

Related U.S. Application Data
(60) Provisional application No. 63/134,775, filed on Jan. 7, 2021.

(51) Int. Cl. C08J 9/26; C09J 163/00; C09J 11/08; C08L 23/16; C09K 3/10

(52) U.S. Cl. CPC C08J 9/26; C09J 163/00; C09J 11/08; C08L 23/16; C09K 3/1025; C08L 2205/035; C08L 2205/025; C08L 2203/14; C09K 2200/0642; C08J 2201/046; C08J 2323/16

(57) ABSTRACT

A composition comprising a fiber component having a melt/softening temperature and a matrix material for mixing with the fiber component, wherein the composition experiences a vertical rise of at least about 0.5 mm in the absence of any blowing agent when exposed to an elevated temperature of at least about 70° C.

### TECHNICAL FIELD

The present invention relates generally to adhesives and sealants formulated to change shape, fill a gap, and/or join two or more substrates together, where typical chemical or physical blowing agents are replaced with fiber materials.

### BACKGROUND

A variety of industries utilize polymer-based materials for sealing and adhering. The use of adhesives and sealants is widespread in the automotive and construction industries as well as in certain consumer product industries such as sporting equipment, shoes, furniture, and other goods where strong adhesion and/or sealing is necessary. These materials are often activatable, meaning that they are formulated to change shape, foam, expand and/or cure upon exposure to a stimulus.

There is an ongoing effort to develop sealant and adhesive materials that foam with the use of minimal chemical and physical blowing agents, as some blowing agents may have negative environmental impacts, reduce physical properties, and be a source of odors. Further, the use of these blowing agents creates porosity or voids in the material that can reduce certain physical strength characteristics.

Chemical blowing agents decompose on heating to release gas into a matrix, typically a polymer or polymeric composition. The released gas expands in accordance with the ideal gas law, causing the matrix to grow in volume by creating a cellular structure and in doing so reduce density and change dimensions. Physical blowing agents are typically hollow thermoplastic balls filled with low boiling point organic materials such as isobutane although non-encapsulated volatile materials distributed through the material can be used as well to create foaming as well. When physical blowing agents in a matrix are heated, the thermoplastic shell softens and the low boiling point organic solvent boils causing pressure in the softened shell resulting in the expansion of the shell thereby increasing the volume of the matrix and reducing its density.

In automotive body construction, for example, gaps between metal surfaces appear due to imperfect alignment of mating of opposing surfaces. Adhesive and or sealing materials use chemical and physical blowing agents commonly to expand and change in volume to bond these surfaces and/or fill these gaps. There are limitations, however, to the use of these ingredients.

In contrast, the teachings herein utilize oriented polymeric fibers as a method to achieve an increase in the vertical dimension of a matrix or compounded material during heat exposure without the creation of a cellular structure or reduced density. The oriented fibers incorporated into the composition experience a change in entropic state to provoke a change in the vertical dimension of a mixture to achieve contact with an opposing surface to enable bonding and adhesion.

### SUMMARY OF THE INVENTION

The teachings herein are directed to a composition comprising a fiber component having a melt/softening temperature, and a matrix material for combining with the fiber component, wherein the composition experiences a vertical rise of at least about 0.5 mm in the absence of any blowing agent when exposed to an elevated temperature of at least about 70° C.

The fiber component may include fibers having a length of from about 0.05 mm to about 50 mm. The fiber component may include polymeric fibers. The fiber component may be included in an amount of about 0.5% to about 10% by weight of the composition.

The matrix material may be an epoxy-based material. The matrix material may be an ethylene-based material. After exposure to the elevated temperature the composition may have a lap shear that is not more than 30% less than the lap shear of a composition that is free of the fiber component. After exposure to the elevated temperature the composition may have a vertical expansion percentage that is not more than 30% less than the vertical expansion percentage of a composition that is free of the fiber component and instead includes a blowing agent.

The composition may include a rubber component. After exposure to the elevated temperature the composition may have a vertical expansion percentage of at least 200%, at least 300%, or even at least 400%.

The fiber component may include polyethylene fibers. The fiber component may be located onto one or more surfaces of the matrix material. The fiber component may be mixed into the matrix material to form a substantially homogeneous material. The fiber component may include a single type of fiber. The fiber component may include at least two types of fibers.

After exposure to the elevated temperature the composition may be substantially free of porosity. The composition may have a melt temperature of less than 200° C., or even less than 100° C. The composition may be tacky prior to exposure to the elevated temperature.

The teachings herein are further directed to a method of making the compositions described herein including combining the fiber component and matrix material at a temperature that is above a softening temperature of the matrix material but below the softening temperature of the fiber component.

The teachings herein are also directed to use of the compositions described herein for adhering, sealing, or reinforcing.

### DETAILED DESCRIPTION

The present teachings meet one or more of the above needs by the improved processes and materials described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein address activatable materials that may be adhesives in nature, sealants in nature, or have some combination of adhesive and sealant characteristics. The activatable material may be considered structural in nature such that upon activation and/or cure, the material is capable of providing structural support. As used herein the phrase adhesive/sealant is defined to encompass materials that are adhesive in nature, sealing in nature, or some combination thereof. The adhesive/sealant material may be injection molded and or extruded. The adhesive/sealant material may be formed as a tape. The adhesive/sealant material may be a pressure sensitive material. The adhesive material may be a paste prior to activation.

The adhesive/sealant material may include one or more polymeric fiber components. Such components may be utilized to increase the vertical height of the material upon exposure to a stimulus, which may be heat. It is typical in the production of polymeric fibers that the fibers will become oriented along the length of the axis of the fiber through either an extrusion process, drawing process, or a combination of the two processes. When oriented fibers are exposed to temperatures that are above their melting or softening point, they will typically relax and draw back to a less oriented or unoriented state which is manifested in the fiber shrinking in length. From a thermodynamic standpoint, the oriented fibers represent a lower entropic state. With an increase in temperature, molecular movement is enabled to allow the fibers to go to a higher entropic state. Therefore, this shrinkage of synthetic fibers is largely a generalized behavior displayed by many types of fibers. With regard to the present teachings, this phenomenon is employed in an activatable adhesive/sealant formulation (e.g., one that is intended to expand) to achieve the effect of increasing height in the vertical direction without aid of a physical or chemical blowing agent.

Another advantage to the use of fibers to replace typical chemical and physical blowing agents is odor reduction. The decomposition of chemical blowing agents often creates chemical species known to cause disagreeable odors. Odor is of significant concern for many in the manufacturing sector. The use of synthetic fibers to cause a change in the vertical direction of a material does not create decomposition products and therefore can result in a material with reduced odor compared to one in which a chemical blowing agent is used.

Further, the cellular structure or porosity created within a matrix by expansion caused by traditional blowing agents reduces mechanical properties such as tensile elongation. It also reduces adhesion resistance after humid environmental exposure. An additional significant advantage gained through the use of fibers as a replacement to blowing agents is that it allows for the creation of materials capable of changing in the vertical dimension without creating porosity or demonstrating a loss of physical properties.

The teachings herein describe adhesives/sealants with higher over-lap shear maximum stress resistance, higher average peel values, and better resistance to accelerated environmental exposure conditions compared to materials made with traditional blowing agents. This is accomplished by maintaining the adhesive/sealant matrix as dense as possible without creating a cellular structure within the adhesive as well as not creating decomposition by-products seen in the decomposition of traditional blowing agent chemistries.

Finally, chemical blowing agents may react with other constituents in a formulated product prior to activation through heat or another mechanism. A typical result of this type of occurrence would be reduced shelf stability prior to activation. Fibers included in the composition to create vertical rise typically would be non-chemically reactive within the composition.

One specific use of the adhesives described herein is for the filling of gaps in cavities or between two or more surfaces to be bonded. The change in vertical dimension allows for the adhesive to mate surfaces separated by gaps of inconsistent sizes.

The tendency of the fibers described herein to cause expansion in the vertical direction of an adhesive as a result of a change in entropic state of the fibers could be used in any adhesive/sealant matrix material, whether it be thermosetting, thermoplastic, or not. The adhesive is preferably exposed to a stimulus to cause the change in entropic state. This stimulus may be from the exposure to heat directly such as, but not limited to, ovens, IR lamps, induction or localized heating.

A compliant state of the matrix is reached when the rheological properties of the adhesive matrix allow the change in entropic state of the fibers to cause a change in the dimension of the matrix. Fibrous materials, having a known reinforcing and thixotropic affect, can increase the viscosity of the matrix. This increased viscosity influences the melt behavior of a material, reducing the compliance and lowering the wetting ability of an adhesive. When an adhesive is able to more effectively wet mating surfaces, the bond strength is improved. For this reason, a balance must be achieved between the amount and type of fiber used and the desired change in dimension.

It may also be beneficial that the solidifying material mixture be able to maintain the dimensional change. Therefore, a correlation in the melt temperatures of the mixture and fiber, as well as their crystallization and or crosslinking temperatures may result in optimal vertical expansion. However, it is also possible that the adhesive or sealant wet a mating surface without cross-linking. It is further possible that the cooling material will maintain the dimensional change, or the adhesive nature of the material will remain bonded to the joining surface despite a lack of complete or partial cross-linking.

Another consideration is the affinity of the fiber with the polymeric matrix. Such affinity or lack thereof may also influence the dimensional change. It is possible that the fiber may drag or draw the matrix with it when the fiber changes entropic state or shrinks. This may be the mechanism by which the mixture changes dimension. Fibrillated as well as linear strand fibers may produce this change given proper dispersion within the matrix. This dispersion, or entanglement may be accomplished through traditional processing techniques such as, but not limited to, planetary, double-arm, sigma-blade, Banbury, or Brabender type mixers as well as extruder compounding. Other high shear techniques such as speed-mixers may also work.

A blend of fibers is also a possibility. It may be beneficial to select two or more different fibers with different softening points which would change entropic states at different moments of the curing process, as the material was exposed to heat or came to temperature. Alternatively, one or more fibers could be utilized as a thixotropic agent, with softening points above the curing conditions of the material, and a different fiber or fibers could be utilized as entropic agents to change the vertical dimension of the material, with softening points much closer to the curing temperatures employed.

During manufacture of the materials described herein, mixing or other processing temperatures may be avoided that exceed the melting or softening point of the fiber. Should the mixture be extruded, injection molded, thermal-formed or otherwise transformed after preparation, the temperature may not exceed that which will initiate the change in entropic state of the additive. If processing temperatures exceed the softening point of the fiber, the fiber may shrink before the adhesive has been formed, extruded or shaped. Once in their higher entropic state, it is possible that the fibers will not readily go back into their lower entropic state and thus may no longer influence the vertical dimension of the adhesive.

In one non-limiting example, a polyethylene fiber was used in a hot-melt processable adhesive. A mixture of solid and liquid resins are blended at temperatures high enough to melt the resin component of the matrix. Before adding the fiber additive, the mixture was cooled to a temperature below the melting or softening point of the fiber. Other polymeric fibers may be used and would be of interest depending on the processing conditions and exposure temperatures of the adhesive. The length of the fiber may have an impact on the expansion behavior from the entropic change. Fiber lengths of 0.05 mm to up 50 mm may be utilized, but other lengths would work as well.

As an example, the adhesive may be tacky to the touch or slightly tacky to the touch with an initial storage modulus between about 1 and about 50 MPa, although dry to the touch materials with higher initial storage moduli may also be utilized as well as paste-like materials. The adhesive may have an initial thickness of about 1.25 mm after extrusion, calendaring, pressing or otherwise shaping the material, with an increase in the vertical dimension by up to 500% or more after the entropic change of the fiber or fibers. In another example, the adhesive may have an initial thickness of 1.25 mm, and may be adapted to bond metal plates separated by a distance of, but not limited to, 1.5 mm.

The expansion of materials which can expand up to 500% or more with traditional blowing agents is typically multi-directional expansion. This can cause material to seep out of the bond area and affect surrounding surfaces. In certain situations, this excess material must be removed by physical means, requiring additional work and quality control from the manufacturing process. In contrast, this invention is expected to reduce or eliminate the amount of material which expands outside of the bond area because the expansion in the vertical direction from a change in entropic state of an additive such as fibers is not expected to change the final volume of the applied adhesive.

The adhesives described herein may be an epoxy-based adhesive containing solid or liquid resins or a blend thereof. The epoxy can consist of Bisphenol-A, Bisphenol-F, phenol, cresol novolac resins, or any combination thereof. The epoxy resins may be mono-functional, di-functional or multi-functional, or any combination thereof. The adhesive may contain impact modifiers such as epoxy modified rubber, core-shell particles or high molecular weight thermoplastics or any combination thereof. The adhesive may contain cross-linking agents such as imidazoles or various amine containing compounds.

An example adhesive is shown below in Table 1.

TABLE 1

| Formulation | A |
|---|---|
| Phenoxy Resin in dissolution | 12.68 |
| Solid epoxy resin | 11.71 |
| Core-shell impact modifier | 35.50 |
| Flexibilizer 1 | 5.80 |
| Flexibilizer 2 | 5.80 |
| Epoxy-terminated dicarboxylic acid | 1.45 |
| Adduct | |
| Polyethylene Fibers (2.2 dpf × 1/4″) | 4.00 |
| Calcium Carbonate | 10.43 |
| Pigment | 8.16 |
| Carbon Black | 0.97 |
| Dicyandiamide curing agent | 3.00 |
| Curing agent accelerator | 0.50 |
| Total: (%) | 100.00 |
| Bake: 25 min at 325° F. | |
| Vertical Rise from 1.25 mm Initial | >500% |

In one non-limiting example, polyethylene fibers are used to create an increase in vertical dimension of a thermoset epoxy adhesive. The mechanical properties of this mixture are compared with an epoxy adhesive without the fibers, as well as the same adhesive using a chemical blowing agent to obtain a similar change in vertical dimension instead of the fibers. The resulting values are shown below in Table 2. It must be noted that although no blowing agent or entropic change additive (e.g., fiber) was used in the base epoxy adhesive, a change in vertical dimension was still observed. This is the result of stress and relaxation from the polymeric component of the adhesive. For determining the physical characteristics addressed below in Table 2, sample preparation is as follows: Volume expansion according to SAE J1918 with initial material dimension of 12×62×1.2 mm. Percent vertical rise is calculated from the ratio of the difference of the final height minus the initial height to the final height based on initial material of 25×25×1.2 mm in dimension. Metal Preparation: Ferrocote 61 Mal HCL 1 stamping oil was applied at 3 g/m² to galvanized steel that was previously wiped with acetone. The metal thickness is 1.5 mm. An initial bond area of 12×25.4 mm was used and samples were tested at 50 mm/min.

TABLE 2

| | No Blowing | | |
|---|---|---|---|
| | Agent | Fibers | Blowing Agent |
| | Formulation | | |
| | B | C | D |
| 25 min at 325° F. | | | |
| Volume Expansion (%) | 2 | 1 | 267 |
| Percent vertical rise (%) | 41 | 314 | 375 |
| Lap Shear (MPa) | | | |
| 1.5 mm Total Gap | 18.3 | 17 | 2.8 |
| 2 mm Total Gap | 13.5* | 11.1 | 2.7 |
| 2.5 mm Total Gap | Did not jump gap | 9.1 | 2.8 |
| 3 mm Total Gap | Did not jump gap | 9.4 | 2.4 |

Lap Shear average of 3 samples

*Only 1 sample bonded

In another example set forth below in Table 3, Polyethylene fibers are used to replace the chemical blowing agent in a solid, granulatable, injection moldable thermoset epoxy adhesive. With similar sample preparation as the examples from Table 2, the results in Table 3 were obtained. A higher volume expansion in Formulation F, compared to Formulation C has been measured due to the densification after injection molding and subsequent relaxation of the material upon exposure to curing temperatures. T-Peel specimens were prepared using 0.7 mm galvanized steel with a bond area of 25.4×75 mm and tested at 50 mm/min. Dog bone tensile specimens of dimensions listed under JISK 6301-1 MET were cut from 2.7 mm thick material cured between steel plates separated by a gap of 3 mm and tested at 5 mm/min.

TABLE 3

| | Chemical | |
|---|---|---|
| | Blowing | |
| | Agent | Fibers |
| | Formulation | |
| Bake: 25 min at 325° F. | E | F |
| 3 mm Volume Expansion % | 101 | 52 |
| 3 mm Vertical Increase % | 116 | 101 |
| Laps 2.7 for 3 on 1.8 mm EG60 61Mal (MPa) | 5.41 | 5.94 |
| T-Peel 1.2 for 1.5 on 0.75 mm EG60 61Mal (N/mm) | 2.38 | 3.5 |
| Tensile Stress (MPa) | 18.1 | 22.1 |
| Tensile Modulus (MPa) | 1960 | 2296 |
| Tensile Strain (%) | 1.23 | 1.62 |

It should be noted that it is possible to have volume expansion without addition of a chemical or physical blowing agent. Typically, this is due to either the presence of moisture (water) that will in turn produce steam, or the presence of entrapped air introduced during that compounding operation that will increase in volume and increase porosity upon heating. Neither of these methods are reliable for obtaining consistent and predictable volume expansion. These two factors are the primary reason for observing volume expansion of compositions when exposed to elevated temperatures that do not contain blowing agents.

In the examples in table 4 below, polymeric fibers with a softening point of around 127° C. are used with a thermoset epoxy adhesive. The melt point of the fibers is measured at 135° C. which is within 5° C. of the temperature of lowest viscosity of the formulations. Varying the onset of cross linking of the adhesive by varying the amount of accelerator shows that increased lap shear and T-peel values are obtained with formulations which cross-linked at higher temperatures. These values are shown below in Table 4. The same test methods used to gather the information in Table 2 were used with the following differences in sample preparation. Metal Preparation: Ferrocote 61 Mal HCL 1 stamping oil was applied at 3 g/m² to galvanized steel that was previously wiped with acetone. For Lap Shear the metal thickness is 1.5 mm. The initial adhesive thickness is 1.25 mm and the final adhesive thickness is 1.5 mm. For T-Peel the metal thickness is 0.7 mm, the initial adhesive thickness is 0.7 mm, and the final adhesive thickness is 0.75 mm which was obtained by using glass beads. For tensile testing, the initial adhesive thickness is 3 mm and the final adhesive thickness is −4 mm. The DSC testing was performed on samples 3-4 mg in weight and tested from 50° C. to 300° C. at 20K/min.

TABLE 4

| Formulation | G | H | I |
|---|---|---|---|
| DSC Onset (° C.) | 143.8 | 147.0 | 153.0 |
| DSC Peak (° C.) | 157.2 | 162.1 | 168.5 |
| Bake: 25 min at 325° F. | | | |
| Lap Shear (MPa) | 11.28 | 12.19 | 12.95 |
| T-Peel (N/mm) | 4.61 | 4.36 | 5.08 |
| Tensile Stress (MPa) | 19.8 | 18.6 | 18.1 |
| Tensile Modulus (MPa) | 1666 | 1710 | 1688 |
| Tensile Strain (%) | 2.41 | 1.84 | 1.2-2.8 |

In another example set forth below in Table 5, polymeric fibers are utilized in an EPDM (ethylene propylene diene monomer) based sealant. The same entropic mechanism produces a change in the vertical dimension of the mixture. In similar formulations, a chemical or physical blowing agent would have had to be used to produce similar results. Odor reduction from the use of these polymeric fibers is a significant benefit in this type of formulation. In addition, in sealant formulations it is possible that water, other liquids, or gas permeability would be reduced as compared to a cellular structured material (such as those formed with traditional blowing agents).

TABLE 5

| Formulation | Formulation J |
|---|---|
| Paraffinic process oil | 13.59 |
| EPDM | 14.37 |
| Carbon Black | 8.62 |
| Liquid polybutene polymer/ | 14.48 |
| polyisobutylene modifier | |
| Tackifying agent | 1.65 |
| Low molecular weight polyethylene | 1.94 |
| Pigment | 19.87 |
| Magnesium carbonate-treated sulfur | 0.29 |
| Polyethylene fibers (2.2 dpf × 1/4″) | 4.00 |
| bisphenol-A dimethacrylate | 0.14 |
| Silicon dioxide | 0.06 |
| Zinc oxide | 1.46 |
| Calcium carbonate | 22.74 |
| Total: (%) | 100.00 |
| Bake: 25 min at 325° F. | |
| Vertical Rise from 1.25 mm Initial | >500% |

It is possible that the adhesives or sealants described herein may comprise polyolefins, silicones, rubbers, or combinations thereof. It is possible that the polymeric fibers described herein may be substantially homogeneously distributed throughout the adhesive or sealant. Alternatively, the polymeric fibers may be localized in only a specific portion of the adhesive or sealant or can be produced as laminated sheets with some sheets containing activatable fibers and other not. For example, the fibers may be located onto a single surface side of an adhesive, or in a thin layer onto the adhesive. The fibers may be co-extruded with the adhesive onto one surface of the adhesive or substantially within the adhesive. Such localization may cause desirable movement of the material in a particular direction. Such localization may also assist in minimizing any detrimental effects from differing coefficients of thermal expansion of the materials the adhesive is utilized to adjoin.

Epoxy resin-based materials can be particularly suitable for the adhesive/sealant materials of the present teachings. Epoxy resin is used herein to mean any of the conventional dimer, oligomer or polymer epoxy materials containing at least one epoxy functional group. The polymer-based materials may be epoxy containing materials having one or more oxirane rings polymerizable by a ring opening reaction. It is possible that the adhesive/sealant material includes up to about 80% of an epoxy resin. More preferably, the adhesive/sealant includes between about 5% and 60% by weight of epoxy containing materials.

The epoxy resin containing materials may be aliphatic, cycloaliphatic, aromatic or the like. The epoxy may be supplied as a solid (e.g., as pellets, chunks, pieces, or the like) or a liquid (e.g., a liquid epoxy resin) or both. The epoxy may be blended with one or more ethylene copolymers or terpolymers that may possess an alpha-olefin. As a copolymer or terpolymer, the polymer is composed of two or more different monomers, i.e., small chemically reactive molecules that are capable of linking up with each other or similar molecules. Preferably, an epoxy resin is added to the adhesive/sealant material to increase the flow properties of the material. One exemplary epoxy resin may include a bisphenol-A epichlorohydrin ether polymer, or a bisphenol-A epoxy resin which may be modified with butadiene or another polymeric reactant.

One or more of the epoxy-containing materials may be provided to the adhesive/sealant material as an epoxy/elastomer hybrid, e.g., a blend, copolymer or adduct that has been previously fabricated. The epoxy/elastomer hybrid, if included, may be included in an amount of up to about 90% by weight of the adhesive/sealant material. Typically, the epoxy/elastomer hybrid is approximately from about 1% to about 50% and more typically is approximately from about 5% to about 20% by weight of the adhesive/sealant material.

In turn, the epoxy elastomer itself generally includes about 1:5 to 5:1 parts of epoxy to elastomer, and more preferably about 1:3 to 3:1 parts of epoxy to elastomer. In one preferred embodiment, the epoxy/elastomer hybrid preferably includes approximately from about 40% to about 80% of an epoxy resin (such as disclosed in the above), and from about 20% to about 60% of an elastomer compound. The elastomer compound may be any suitable art disclosed thermoplastic elastomer, thermosetting elastomer, or a mixture thereof. Exemplary elastomers include, without limitation natural rubber, styrenebutadiene rubber, polyisoprene, polyisobutylene, polybutadiene, isoprene-butadiene copolymer, neoprene, nitrile rubber, butyl rubber, polysulfide elastomer, acrylic elastomer, acrylonitrile elastomers, silicone rubber, polysiloxanes, polyester rubber, diisocyanate-linked condensation elastomer, EPDM (ethylene propylene diene rubbers), chlorosulphonated polyethylene, fluorinated hydrocarbons and the like. In one embodiment, recycled tire rubber is employed.

The epoxy/elastomer hybrid, when added to the adhesive/sealant material, preferably is added to modify structural properties of the adhesive/sealant material such as strength, toughness, stiffness, flexural modulus, or the like. Additionally, the epoxy/elastomer hybrid may be selected to render the adhesive/sealant material more compatible with coatings such as water-borne paint or primer system or other conventional coatings.

Rubber or an elastomer may also be added to the adhesive/sealant material as a separate ingredient. Again, the elastomer compound may be a thermoplastic elastomer, thermosetting elastomer or a mixture thereof or otherwise. Exemplary elastomers include, without limitation, natural rubber, styrene-butadiene rubber, polyisoprene, polyisobutylene, polybutadiene, isoprene-butadiene copolymer, neoprene, nitrile rubber, butyl rubber, polysulfide elastomer, acrylic elastomer, acrylonitrile elastomers, silicone rubber, polysiloxanes, polyester rubber, diisocyanate-linked condensation elastomer, EPDM (ethylene propylene diene rubbers), chlorosulphonated polyethylene, fluorinated hydrocarbons and the like. In one embodiment, recycled tire rubber is employed. The elastomer or rubber, whether added as part of a hybrid or adduct or on its own, is a substantial portion of the adhesive/sealant material. The elastomer or rubber can be at least 10%, more typically at least 20% and possibly at least 35% or at least 55% by weight of the adhesive/sealant.

It is possible that one or more polymers may be incorporated into the adhesive/sealant material, e.g., by copolymerization, by blending, or otherwise. For example, without limitation, other polymers that might be appropriately incorporated into the adhesive/sealant material include halogenated polymers, polycarbonates, polyketones, urethanes, polyesters, silanes, sulfones, allyls, olefins, styrenes, acetates, ethylene vinyl acetates, acrylates, methacrylates, epoxies, silicones, phenolics, rubbers, polyphenylene oxides, terphthalates, or mixtures thereof. Other potential polymeric materials may be or may include, without limitation, polyethylene, polypropylene, polystyrene, polyolefin, polyacrylate, poly(ethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methylmethacrylate), poly(vinyl acetate), poly(vinylidene chloride), polytetrafluoroethylene, polyisoprene, polyacrylamide, polyacrylic acid, polymethacrylate, polyacetals or mixtures thereof.

The adhesive/sealant material may include an acrylate copolymer, an acetate copolymer or both. The adhesive/sealant material may include ethylene methyl acrylate (EMA), ethylene vinyl acetate (EVA) or a combination thereof. When included, EMA is typically between about 1% and about 70%, more typically between about 30% and about 60% and even more typically between about 44% and about 55% by weight of the adhesive/sealant material. A desirable EMA can have a melt index between about 110 and about 150 grams/10 min. (e.g., about 135 grams/10 min.). When included, EVA is typically between about 1% and about 70%, more typically between about 2% and about 10% and even more typically between about 3% and about 5% by weight of the melt flow material.

It is also contemplated that the adhesive/sealant material can include one or more isocyanate reactive ingredients (e.g., polyols), which can be reactive with blocked isocyanates. Example of such ingredients and isocyanates are disclosed in U.S. Patent Application, Publication No. 2005/0320027, which is incorporated herein by reference for all purposes.

It is also possible that the adhesive/sealant material can also include one or more materials for controlling the rheological characteristics of the adhesive/sealant material over a range of temperatures (e.g., up to about 250° C. or greater). Any suitable art-disclosed rheology modifier may be used, and thus the rheology modifier may be organic or inorganic, liquid or solid, or otherwise. The rheology modifier may be a polymer, and more preferably one based upon an olefinic (e.g., an ethylene, a butylenes, a propylene or the like), a styrenic (e.g., a styrene-butadiene-containing rubber), an acrylic or an unsaturated carboxylic acid or its ester (such as acrylates, methacrylates or mixtures thereof; e.g., ethylene methyl acrylate (EMA) polymer) or acetates (e.g., EVA). The rheology modifier may be provided in a generally homogeneous state or suitable compounded with other ingredients. It is also contemplated that the various clays, minerals or other materials discussed in relation to reinforcing particulates below can be employed to modify rheology of the adhesive/sealant material.

The adhesive/sealant material may also include one or more curing agents and/or curing agent accelerators. Amounts of curing agents and curing agent accelerators can vary widely within the adhesive/sealant material. Exemplary ranges for the curing agents, curing agent accelerators or both present in the adhesive/sealant material range from about 0% by weight to about 7% by weight.

Preferably, the curing agents assist the adhesive/sealant material in curing by crosslinking of the polymers, epoxy resins or both. It is also preferable for the curing agents to assist in thermosetting the adhesive/sealant material. Useful classes of curing agents are materials selected from aliphatic or aromatic amines or their respective adducts, amidoamines, polyamides, cycloaliphatic amines (e.g., anhydrides, polycarboxylic polyesters, isocyanates, phenol-based resins (such as phenol or cresol novolak resins, copolymers such as those of phenol terpene, polyvinyl phenol, or bisphenol-A formaldehyde copolymers, bishydroxyphenyl alkanes or the like), or mixtures thereof. Particular preferred curing agents include modified and unmodified polyamines or polyamides such as triethylenetetramine, diethylenetriamine tetraethylenepentamine, cyanoguanidine, dicyandiamides and the like. If an accelerator for the curing agent is used examples of materials includes a modified or unmodified urea such as methylene diphenyl bis urea, an imidazole or a combination thereof. Other preferred curing agents can include peroxides, such as bis(t-butylperoxy)diisopropylbenzene, 1,1-di-t-butylperoxy-3,3,5-trimethylcyclohexane, 4,4-di-t-butylperoxy n-butyl valerate, dicumyl peroxide, and the like.

The adhesive/sealant material may also include one or more reinforcing particulates, including but not limited to particulated materials (e.g., powder), beads, microspheres, or the like. Preferably the reinforcing particulates include a relatively low-density material that is generally non-reactive with the other components present in the adhesive/sealant material.

Examples of such reinforcing particulates include silica, diatomaceous earth, glass, clay, talc, pigments, colorants, glass beads or bubbles, carbon ceramic fibers, antioxidants, and the like. Some of these reinforcing particulates, particularly clays, can assist the adhesive/sealant material in leveling itself during flow of the material. The clays that may be used as reinforcing particulates may include clays from the kaolinite, illite, chloritem, smecitite or sepiolite groups. Examples of suitable reinforcing particulates include, without limitation, vermiculite, pyrophyllite, sauconite, saponite, nontronite, montmorillonite or mixtures thereof. The clays may also include minor amounts of other ingredients such as carbonates, feldspars, micas and quartz. The reinforcing particulates may also include zinc oxide, silicon dioxide or ammonium chlorides such as dimethyl ammonium chloride and dimethyl benzyl ammonium chloride. Titanium dioxide might also be employed.

In one preferred embodiment, one or more mineral or stone type particulates such as calcium carbonate, sodium carbonate or the like may be used. In another preferred embodiment, silicate minerals such as mica may be used. It has been found that silicate minerals and mica, in particular, can assist in leveling the adhesive/sealant material.

When employed, the reinforcing particulates in the adhesive/sealant material can range from 10% to 90% by weight of the adhesive/sealant material. According to some embodiments, the adhesive/sealant material may include from about 0% to about 3% by weight, and more preferably slightly less than 1% by weight of reinforcing particulates. Powdered (e.g., about 0.01 to about 50, and more preferably about 1 to 25 micron mean particle diameter) mineral type particulates can comprise between about 5% and 70% by weight, more preferably about 40% to about 60%, and still more preferably approximately 55% by weight of the adhesive/sealant material.

Other additives, agents or performance modifiers may also be included in the adhesive/sealant material as desired, including but not limited to a UV resistant agent, a flame retardant, an impact modifier, an adhesion promoter, a heat stabilizer, a colorant, a processing aid, a lubricant, or any combination thereof. One preferred additive is an adhesion promoter such as a hydrocarbon resin. Another preferred additive is a coagent such an acrylate coagent.

Once formed, the adhesive/sealant material typically has a melt temperature less than about 200° C., more typically less than about 140° C. and even more typically less than about 100° C., but typically greater than about 30° C., except for pressure sensitive tape and paste compositions, more typically greater than about 50° C. and even more typically greater than about 65° C., although higher or lower melt temperatures are possible depending upon the manner of application of the adhesive/sealant material.

The adhesives described herein may include an impact modifier, which may comprise a rubber-based material. The impact modifier may be a core shell polymeric material. As used herein, the term core shell polymer denotes a polymeric material wherein a substantial portion (e.g., greater than 30%, 50%, 70% or more by weight) thereof is comprised of a first polymeric material (i.e., the first or core material) that is substantially entirely encapsulated by a second polymeric material (i.e., the second or shell material). The first and second polymeric materials, as used herein, can be comprised of one, two, three or more polymers that are combined and/or reacted together (e.g., sequentially polymerized) or may be part of separate or same core/shell systems. The core shell polymer should be compatible with the formulation (prior to cure) and preferably has a ductile core and a rigid shell which is compatible with the other components of the adhesive/sealant formulation.

The first and second polymeric materials of the core/shell polymer can include elastomers, polymers, thermoplastics, copolymers, other components, combinations thereof or the like. In preferred embodiments, the first polymeric material, the second polymeric material or both include or are substantially entirely composed of (e.g., at least 70%, 80%, 90% or more by weight) one or more thermoplastics. Exemplary thermoplastics include, without limitation, styrenics, acrylonitriles, acrylates, acetates, polyamides, polyethylenes or the like.

Preferred core/shell polymers are formed by emulsion polymerization followed by coagulation or spray drying. It is also preferred for the core/shell polymer to be formed of or at least include a core-shell graft co-polymer. The first or core polymeric material of the graft copolymer preferably has a glass transition temperature substantially below (i.e., at least 10, 20, 40 or more degrees centigrade) the glass transition temperature of the second or shell polymeric material. Moreover, it may be desirable for the glass transition temperature of the first or core polymeric material to be below 23° C. while the glass temperature of the second or shell polymeric material to be above 23° C., although not required.

Examples of useful core-shell graft copolymers are those where hard containing compounds, such as styrene, acrylonitrile or methyl methacrylate, are grafted onto a core made from polymers of soft or elastomeric compounds such as butadiene or butyl acrylate. U.S. Pat. No. 3,985,703, describes useful core-shell polymers, the cores of which are made from butyl acrylate but can be based on ethyl isobutyl, 2-ethylhexyl or other alkyl acrylates or mixtures thereof. The core polymer may also include other copolymerizable containing compounds, such as styrene, vinyl acetate, methyl methacrylate, butadiene, isoprene, or the like. The core polymer material may also include a cross linking monomer having two or more nonconjugated double bonds of approximately equal reactivity such as ethylene glycol diacrylate, butylene glycol dimethacrylate, and the like. The core polymer material may also include a graft linking monomer having two or more nonconjugated double bonds of unequal reactivity such as, for example, diallyl maleate and allyl methacrylate.

The shell portion is preferably polymerized from methyl acrylates such as methyl methacrylate and optionally other alkyl acrylates and methacrylates, such as ethyl, butyl, or mixtures thereof acrylates or methacrylates as these materials are compatible with the phenoxy resin and any epoxy resins that are used in the formulation. Up to 40 percent by weight or more of the shell monomers may be styrene, vinyl acetate, vinyl chloride, and the like. Additional core-shell graft copolymers useful in embodiments of the present invention are described in U.S. Pat. Nos. 3,984,497; 4,096,202; 4,034,013; 3,944,631; 4,306,040; 4,495,324; 4,304,709; and 4,536,436. Examples of core-shell graft copolymers include, but are not limited to, “MBS” (methacrylate-butadiene-styrene) polymers, which are made by polymerizing methyl methacrylate in the presence of polybutadiene or a polybutadiene copolymer rubber. The MBS graft copolymer resin generally has a styrene butadiene rubber core and a shell of acrylic polymer or copolymer. Examples of other useful core-shell graft copolymer resins include, ABS (acrylonitrile-butadiene-styrene), MABS (methacrylate-acrylonitrile-butadiene-styrene), ASA (acrylate-styrene-acrylonitrile), all acrylics, SA EPDM (styrene-acrylonitrile grafted onto elastomeric backbones of ethylene-propylene diene monomer), MAS (methacrylic-acrylic rubber styrene), and the like and mixtures thereof.

When determining appropriate components for the activatable material, it may be important to form the material such that it will only activate (e.g., flow, foam or otherwise change states) at appropriate times or temperatures. For instance, in some applications, it is undesirable for the material to be reactive at room temperature or otherwise at the ambient temperature in a production environment. More typically, the activatable material becomes activated to flow at higher processing temperatures. As an example, temperatures such as those encountered in an automobile assembly plant may be appropriate, especially when the activatable material is processed along with the other components at elevated temperatures or at higher applied energy levels, e.g., during painting preparation steps. Temperatures encountered in many coating operations (e.g., in a paint and/or e-coat curing oven), for instance, range up to about 250° C. or higher.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time, and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for ail purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist of, or consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A composition comprising:
a fiber component having a melt/softening temperature;
a matrix material for combining with the fiber component;
wherein the composition experiences a vertical rise of at least about 0.5 mm in the absence of any blowing agent when exposed to an elevated temperature of at least about 70° C.

2. The composition of claim 1, wherein the fiber component includes fibers having a length of from about 0.05 mm to about 50 mm.

3. The composition of claim 1, wherein the fiber component includes polymeric fibers.

4. The composition of claim 2, wherein the fiber component is included in an amount of about 0.5% to about 10% by weight of the composition.

5. The composition of claim 4, wherein the matrix material is an epoxy-based material.

6. The composition of claim 4, wherein the matrix material is an ethylene-based material.

7. The composition of claim 2, wherein after exposure to the elevated temperature the composition has a lap shear that is not more than 30% less than the lap shear of a composition that is free of the fiber component.

8. The composition of claim 1, wherein after exposure to the elevated temperature the composition has a vertical expansion percentage that is not more than 30% less than the vertical expansion percentage of a composition that is free of the fiber component and instead includes a blowing agent.

9. The composition of claim 7, wherein the composition includes a rubber component.

10. The composition of claim 1, wherein after exposure to the elevated temperature the composition has a vertical expansion percentage of at least 200%, at least 300%, or even at least 400%.

11. The composition of claim 2, wherein the fiber component includes polyethylene fibers.

12. The composition of claim 11, wherein the fiber component is located onto one or more surfaces of the matrix material.

13. The composition of claim 1, wherein the fiber component is mixed into the matrix material to form a substantially homogeneous material.

14. The composition of claim 7, wherein the fiber component includes a single type of fiber.

15. The composition of claim 7, wherein the fiber component includes at least two types of fibers.

16. The composition of claim 1, wherein after exposure to the elevated temperature the composition is substantially free of porosity.

17. The composition of claim 14, wherein the composition has a melt temperature of less than 200° C., or even less than 100° C.

18. The composition of claim 1, wherein the composition is tacky prior to exposure to the elevated temperature.

19. A method of making the composition of claim 1 including combining the fiber component and matrix material at a temperature that is above a softening temperature of the matrix material but below the softening temperature of the fiber component.

20. (canceled)

21. A composition comprising:
a polymeric fiber component having a melt/softening temperature, the polymeric fibers having a length of from about 0.05 mm to about 50 mm;
a matrix material comprising an epoxy and/or ethylene-based material for combining with the polymeric fiber component;
wherein the composition experiences a vertical rise of at least about 0.5 mm in the absence of any blowing agent when exposed to an elevated temperature of at least about 70° C.
